(19) United States
(12) Patent Application Publication
(10) Pub. No.: US 2005/0116546 A1
(43) Pub. Date: Jun. 2, 2005

(54) Power supply system

(76) Inventors: Roy M. Zeighami, McKinney, TX (US); Brian M. Johnson, Allen, TX (US); Stuart C. Haden, Lucas, TX (US); Christian L. Belady, McKinney, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/725,720

(22) Filed: Dec. 2, 2003

(51) Int. Cl. H02J 1/10

(52) U.S. Cl. 307/51

(57) ABSTRACT

A power supply system and method are disclosed that may incorporate a plurality of cascading power units arranged in parallel, a connection interface between the plurality of cascading power units and an electronic load, wherein the connection interface prevents current from entering one of the plurality of cascading power units from another of the plurality, and wherein each one of the plurality of cascading power units has a maximum effective output voltage greater than a next one of said plurality.

### TECHNICAL FIELD

The present invention relates in general to electronic systems and, more specifically, to a power supply system.

### BACKGROUND

Larger computer systems and component/cabinet-based systems are usually designed with voltage supplies that are capable of handling multiple upgrades to the chipsets, boards, input/output (I/O) subsystems, and the like. The power supplies normally remain in the system infrastructure while the componentry is replaced and/or upgraded. Typically, each subsequent component generation comes with an increased overall power requirement. Therefore, power supplies typically are only lightly-loaded, by design, during the earlier hardware versions to leave enough head-room or power capacity for the future-upgraded system.

A power supply's efficiency is closely related to the load on the supply. The highest efficiency typically occurs when the power supply is loaded to approximately 85% of its maximum rated current, while the lowest efficiency is usually experienced at load levels below 60%. Some power supplies found in the early versions of the systems may only reach load-levels of 5-10%. In these low-load situations, power is wasted, and the system is much less efficient at this stage.

### SUMMARY

Representative embodiments of the power supply system are directed to a power supply system that may incorporate a plurality of cascading power units arranged in parallel, a connection interface between the plurality of cascading power units and an electronic load, wherein the connection interface prevents current from entering one of the plurality of cascading power units from another of the plurality, and wherein each one of the plurality of cascading power units has a maximum effective output voltage greater than a next one of the plurality.

Additional representative embodiments of the power supply system are directed to a method for supplying power to an electronic load comprising connecting a plurality of power supplies in parallel, setting a maximum effective voltage for each of the plurality of power supplies to cascade from a highest effective voltage for a first of the plurality to a lowest effective voltage for a last of the plurality, and interfacing the plurality of power supplies with the electronic load through an isolation interface.

Further representative embodiments of the power supply system are directed to a power module for supplying power to a load, the power module comprising a plurality of power supplies connected in parallel, wherein each one of the plurality is selected to have a maximum output voltage greater than a next one of the plurality, and a connection interface for connecting the power module to an isolation circuit of the load, wherein the isolation circuit prevents current from one of the plurality of power supplies to sink into another of the plurality of power supplies.

### BRIEF DESCRIPTION OF THE DRAWINGS

FIG. 1 is a block diagram illustrating a power supply module configured according to the teachings herein;

FIG. 2 is a block diagram illustrating another embodiment of a power supply module configured according to the teachings herein;

FIG. 3 is a block diagram illustrating another embodiment of a power supply module configured according to the teachings herein;

FIG. 4 is a flow chart illustrating example steps followed in implementing one embodiment of the present cascading power system; and

FIG. 5 is a flow chart illustrating example steps followed in implementing an additional embodiment of the present cascading power system.

### DETAILED DESCRIPTION

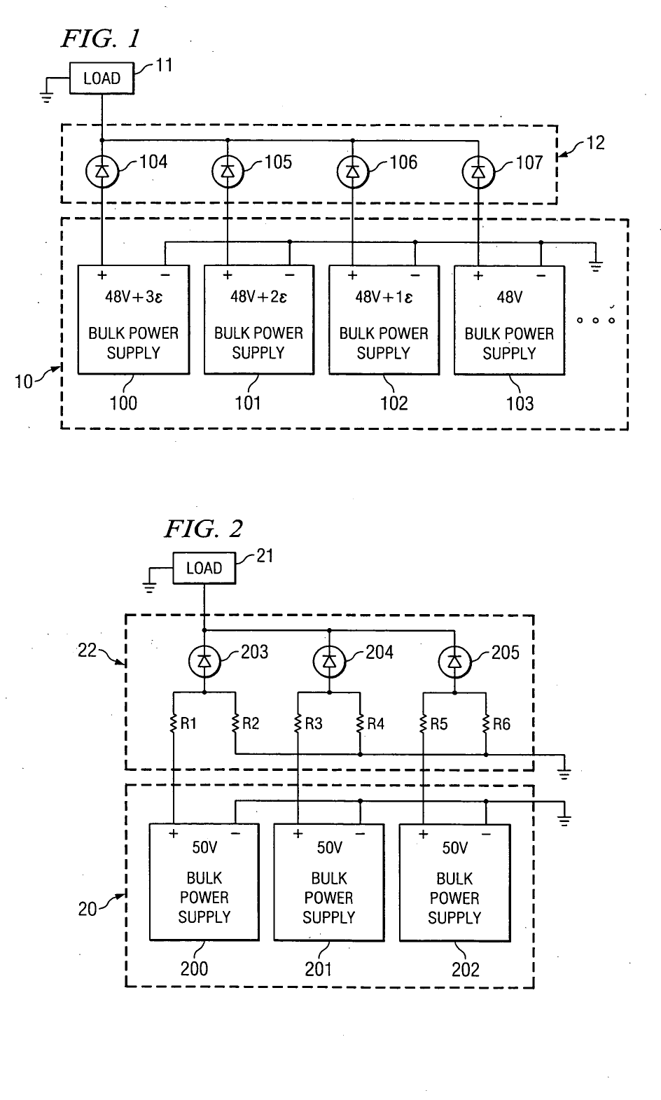

FIG. 1 is a block diagram illustrating power supply module 10 configured according to the teachings herein. Power supply module 10 incorporates individual bulk power supplies 100-103 arranged in parallel. Power supply module 10 supplies power to load 11 through power regulator circuit 12. The positive terminals of bulk power supplies 100-103 are connected to diodes 104-107, respectively, generally to prevent current from sinking into a failed one of bulk power supplies 100-103, should a failure occur. For example, if bulk power supply 100 fails, diode 104 turns off as the voltage on the anode of diode 104 falls below the voltage of its cathode, thus, restricting current from bulk power supplies 101-103 from sinking into failed bulk power supply 100. However, if diode 104 is off, then bulk power supply 100 does not supply any power to load 11, leaving bulk power supplies 101-103 to supply the power to load 11. If the current used by load 11 exceeds the current available from bulk power supplies 101-103, then each of supplies 101-103 will begin to droop (i.e., the maximum output voltage begins to drop).

Power supply module 10 takes advantage of the drooping characteristic by using bulk power supplies 100-103 with cascadingly decreasing voltage levels (e.g., 48.5V, 48.4V, 48.3V, 48.2V, and the like). At the earliest stages of load 11, when the current demand is not very high, bulk power supply 100 may operate while bulk power supplies 101-103 are disconnected due to diodes 105-107 of power regulator circuit 12 also being off. However, as load 11 is modified or upgraded to increase its power requirement from bulk power supply 100 beyond bulk power supply 100's maximum power rating, the output voltage of bulk power supply 100 will begin to droop. Using the exemplary voltage levels referred to above, when bulk power supply 100 droops from 48.5V to 48.4V, diode 105 will turn on, thus, activating bulk power supply 101. The combined power supply will typically provide 48.4V and equally share the current load between bulk power supplies 100 and 101. As load 11 continues to increase its power requirement, bulk power supplies 102 and 103 will cascade on as the overall voltage level droops and then stabilizes at the lowest output voltage of bulk power supplies 100-103.

It should be noted that power supplies may be selected to provide various voltage levels depending on the power requirements of the particular load that the system is being designed for.

FIG. 2 is a block diagram illustrating another embodiment of power supply module 20 configured according to the teachings herein. Power supply module 20 includes bulk power supplies 200-202 each carrying a maximum output voltage of 50 V. Power supply module 20 is, therefore, homogenous. Homogenous power supply module 20 may also be used in a system in a manner as described herein by connecting to load 21 through power selector circuit 22. Power selector circuit 22 includes voltage selecting resistors R1-R6. By selecting the values of R1-R6 at the design stage, the effective voltage supplied to load 21 may be selected with bulk power supplies 200-202 each having the same raw maximum voltage output. When each of power supplies 200-202 are connected to power selector circuit 22, R1 generally reduces the effective voltage seen at diode 203, R3 generally reduces the effective voltage seen at diode 204, and R5 generally reduces the effective voltage seen at diode 205. With the proper selection of R1, R3, and R5, the effective voltage output for power supplies 200-202 may be selected at or tuned to the desired cascading values, such as 48.5V, 48.4V, and 48.3V. By creating the stepped voltage supply from homogenous power supply module 20, various embodiments of the power supply system described herein may be implemented.

It should be noted that the voltage-selecting circuit shown in FIG. 2 is only one example embodiment for creating a stepped effective voltage in power supply module 20. Other methods for creating a voltage drop between any one of power supplies 200-202 and diodes 203-205 may be used.

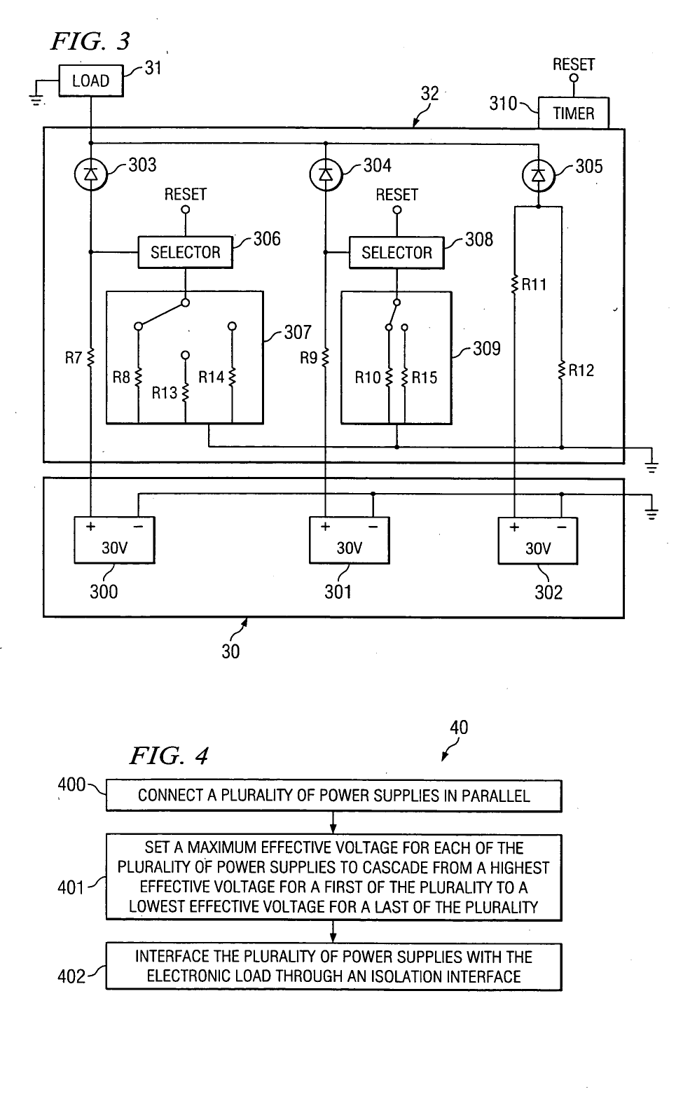

FIG. 3 is a block diagram illustrating another embodiment of power supply module 30 configured according to the teachings herein. Power supply module 30 includes power supplies 300-302. Power selector circuit 32 includes isolation diodes 303-305, selectors 306 and 308, resistor packages 307 and 309, and timer 310. TIMER 310 has a RESET node connected to the RESET of selector 306 and 308. Power supply module 30 is connected to load 31 through power selector circuit 32. The values of R7-R12 are selected to create a initial, stepped power bank of power supplies 300-302. In operation, when power supply 300 is loaded to the point where its effective voltage equals or nearly equals the effective voltage from power supply 301, power supply 301 will turn on and selector 306 disconnects R8 from the voltage divider pair R7/R8 and switches/selects R13 to form a new voltage divider of R7/R13. The value of R13 has been selected, such that the voltage divider formed by R7/R13 holds the effective voltage level of power supply 300 to a maximum of that level for power supply 301. Setting power supply 300 to the maximum effective voltage of power supply 301 prevents power supply 300 from trying to supply its original maximum effective output voltage when power supply 301 relieves some of the loading on power supply 300.

As the voltage or current requirements of load 31 continue to rise, combined power supply 300 and 301 may also begin to droop. If the voltage of combined power supply 300 and 301 reaches the maximum effective voltage of power supply 302, power supply 302 will turn on and selector 306 will disconnect R13 and select R14 to create voltage divider R7/R14, which holds power supply 300 at the maximum effective output voltage of power supply 302. Similarly, selector 307 disconnects R10 and switches/selects R15 to form voltage divider R9/R15, which also holds power supply 301 at the maximum effective output voltage of power supply 302. Setting combined power supply 300 and 301 to the maximum effective voltage of power supply 302 prevents combined power supply 300 and 301 from trying to supply the original combined maximum effective output voltage when power supply 302 relieves some of the loading on combined power supply 300 and 301.

In systems where the power requirements of load 31 may be reduced. Timer 310 may be used to reset selectors 306 and 308 to switch to/or select the original resistors R8 and R10 to form original voltage dividers R7/R8 and R9/R10. Timer 310 may include a periodic signal that allows the latched power supplies to attempt to return to supplying its maximum effective output voltage. In the previous example, if timer 310 signals RESET on selector 306, power supply 300 will attempt to supply its original maximum effective output voltage. The difference in voltages between power supply 300 and power supply 301 will cause diode 304 to deactivate power supply 301 leaving power supply 300 to supply all of the power to load 31. If the power requirements of load 31 have not changed, power supply 300 will again droop to the effective output voltage level of power supply 301 and be limited again by selector 306. However, if the power requirements of load 31 have been reduced, when power supply 301 is unlatched, diode 304 will again deactivate power supply 301 and power supply 300 will supply the power to load 31. If the power requirement of load 31 has been reduced enough, power supply 300 will not droop to the level that would turn power supply 301 on, and the system would return to the initial power supply configuration.

It should be noted that many different methods may be implemented to hold the effective output voltage to the level of the next lowest power supply. The resistance selector system depicted in FIG. 3 represents only one possible embodiment. Some embodiments may use a latching system or potentiometer to control the effect of the voltage drop across the isolation diodes. Moreover, the timer method used to reset the selectors in FIG. 3 is also merely a single possible embodiment for creating an de-selecting mechanism. The methods shown in FIG. 3 are not meant to be limited to solely those ways to implement the power supply system disclosed herein.

FIG. 4 is a flow chart illustrating example steps 40 followed in implementing one embodiment of the present cascading power system. In step 400, a plurality of power supplies are connected in parallel. In step 401, a maximum effective voltage is set for each of the plurality of power supplies to cascade from a highest effective voltage for a first of the plurality to a lowest effective voltage for a last of the plurality. The plurality of power supplies are then interfaced with the electronic load through an isolation interface in step 402.

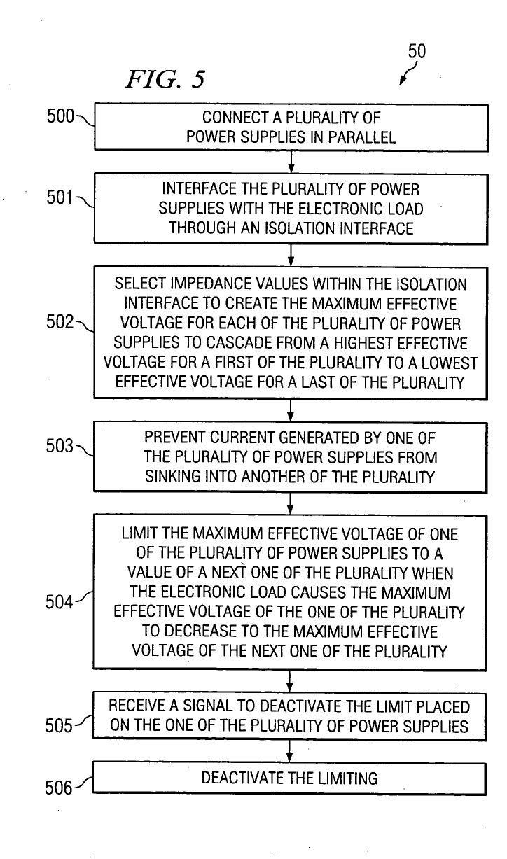

FIG. 5 is a flow chart illustrating example steps 50 followed in implementing an additional embodiment of the present cascading power system. In step 500, a plurality of power supplies are connected in parallel. The plurality of power supplies are then interfaced with the electronic load through an isolation interface in step 501. In step 502, impedance values are selected within the isolation interface to create the maximum effective voltage for each of the plurality of power supplies to cascade from a highest effective voltage for a first of the plurality to a lowest effective voltage for a last of the plurality. In step 503, current generated by one of the plurality of power supplies is prevented by the isolation interface from sinking into another of the plurality. In step 504, the maximum effective voltage of one of the plurality of power supplies is limited to a value of a next one of the plurality when the electronic load causes the maximum effective voltage of the one of the plurality to decrease to the maximum effective voltage of the next one of the plurality. In step 505, a signal may be received to deactivate the limit placed on the one of the plurality of power supplies. In response to receiving such a signal, the limiting is deactivated in step 506.

1. A power supply system comprising:
a plurality of cascading power units arranged in parallel;
a connection interface between said plurality of cascading power units and an electronic load, wherein said connection interface prevents current from entering one of said plurality of cascading power units from another of said plurality; and
wherein each one of said plurality of cascading power units has a maximum effective output voltage greater than a next one of said plurality.

2. The power supply system of claim 1 further comprising:
selection impedance within said connection interface for setting said maximum effective output voltage for each of said plurality of cascading power units.

3. The power supply system of claim 1 wherein said connection interface is disposed within said electronic load.

4. The power supply system of claim 1 further comprising:
a latching component for limiting said maximum effective output voltage of said each one of said plurality of cascading power units to said maximum effective output voltage of said next one of said plurality when a power requirement of said electronic load causes said maximum effective output voltage of said each one of said plurality to reduce to said maximum effective output voltage of said next one of said plurality.

5. The power supply system of claim 4 further comprising:
a latch disable mechanism operable responsive to a signal external to said plurality of cascading power units to deactivate said latching component.

6. The power supply system of claim 5 wherein said signal is transmitted responsive to one or more of:
expiration of a timer;
reduction in said power requirement of said electronic load; and
a user selected option.

7. A method for supplying power to an electronic load comprising:
connecting a plurality of power supplies in parallel;
setting a maximum effective voltage for each of said plurality of power supplies to cascade from a highest effective voltage for a first of said plurality to a lowest effective voltage for a last of said plurality; and
interfacing said plurality of power supplies with said electronic load through an isolation interface.

8. The method of claim 7 wherein said interfacing further comprises:
preventing current generated by one of said plurality of power supplies from sinking into another of said plurality.

9. The method of claim 7 wherein said setting further comprises:
selecting impedance values within said isolation interface to create said maximum effective voltage.

10. The method of claim 7 further comprising:
limiting said maximum effective voltage of one of said plurality of power supplies to a value of a next one of said plurality when said electronic load causes said maximum effective voltage of said one of said plurality to decrease to said maximum effective voltage of said next one of said plurality.

11. The method of claim 10 further comprising:
receiving a signal to deactivate said limiting; and
deactivating said limiting.

12. A power module for supplying power to a load, said power module comprising:
a plurality of power supplies connected in parallel, wherein each one of said plurality is selected to have a maximum output voltage greater than a next one of said plurality; and
a connection interface for connecting said power module to an isolation circuit of said load, wherein said isolation circuit prevents current from one of said plurality of power supplies to sink into another of said plurality of power supplies.

13. The power module of claim 12 further comprising:
a latch circuit operable to limit at least one of said plurality of power sources to said maximum output voltage of said next one of said plurality when a power requirement of said load causes a droop in said maximum output voltage of said at least one of said plurality or power sources to a level of said next one of said plurality.

14. The power module of claim 13 further comprising:
a latch reset for disabling said latch circuit.

15. The power module of claim 14 wherein said latch reset is activated by a timer.
